(19) United States
(12) Patent Application Publication
(10) Pub. No.: US 2014/0080519 A1
(43) Pub. Date: Mar. 20, 2014

(54) METHOD AND SYSTEM FOR PROVIDING LOCATION-AWARE SERVICES

(71) Applicant: Moazzam Rehan Ahmed, Redmond, WA (US)

(72) Inventor: Moazzam Rehan Ahmed, Redmond, WA (US)

(21) Appl. No.: 14/031,028

(22) Filed: Sep. 18, 2013

Related U.S. Application Data
(60) Provisional application No. 61/702,252, filed on Sep. 18, 2012.

(51) Int. Cl. H04W 4/02

(52) U.S. Cl. CPC H04W 4/02
USPC 455/456.3

(57) ABSTRACT

The present disclosure describes a method and system for providing location-aware services. The method enables location-aware business service providers to obtain location-aware services for their users without having to develop and maintain computer software or server systems to provide such services. The disclosed method may also allow location-aware business service providers to customize a generic client system for use by their users, thereby eliminating the need for location-aware business service providers to develop specialized computer software to manage the location-aware services.

### CROSS-REFERENCE TO RELATED APPLICATIONS

This application claims priority to U.S. Provisional Patent Appl. No. 61/702,252, filed on Sep. 18, 2012, the disclosure of which is incorporated herein in its entirety by reference.

### BACKGROUND

1. Field of the Invention

The present disclosure relates to a computerized method and system for providing location-aware services.

2. Description of the Related Art

Location-aware applications and systems are in high demand, and developing and maintaining location-aware applications and systems is often quite costly, as it typically involves custom computer software specifically tailored for its intended application or system.

Location-aware systems generally comprise one or more server systems and one or more client systems. A server system maintains information related to the business service provider such as the provider's business address, product offerings, and prices. A client system generally comprises a user's mobile computing device, such as a smart phone or tablet, and one or more location-aware services applications stored on the device. The server system communicates with the client system via the location-aware services application(s), thereby connecting the business service provider with the user. The server system also maintains information regarding parameters governing communications between the server and client systems, such as whether a given user is allowed to interact with the system, when such interaction is permitted, and other analogous information.

A client system may further comprise a global positioning satellite (GPS) system and a mobile operating system that can transmit data between the client system and the server system on demand, enabling the server system to communicate with the client system and thereby provide location-aware services to the user.

A location-based application or system generally further comprises a method of locating user mobile computing devices, a method of authorizing and registering users, and a method for a user to select a specific location-aware business service provider.

A location-aware application or system may enable users to share information regarding use of the services of a location-aware business service provider via a social network, such as by checking into a particular location, liking or sharing the identity of or information regarding a location-aware business service provider, or providing other information.

A location-aware business service provider must develop and maintain a server system and computer software enabling interaction between the server system and one or more client systems. The software may be uploaded to an application store specific to a particular mobile operating system, such as Android, Apple, Windows Mobile, or BlackBerry.

### SUMMARY

The present disclosure describes a method and system for providing location-aware services. The method enables location-aware business service providers to obtain location-aware services for their users without having to develop and maintain computer software or server systems to provide such services. The disclosed method may also allow location-aware business service providers to customize a generic client system for use by their users, thereby eliminating the need for location-aware business service providers to develop specialized computer software to manage the location-aware services.

### DETAILED DESCRIPTION OF THE DRAWINGS

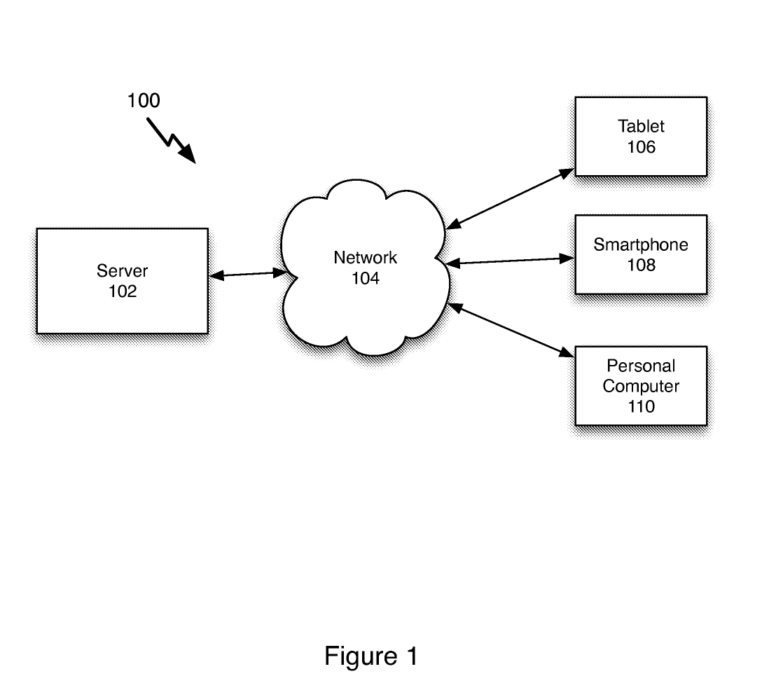

FIG. 1 is a block diagram of an exemplary location-aware system.

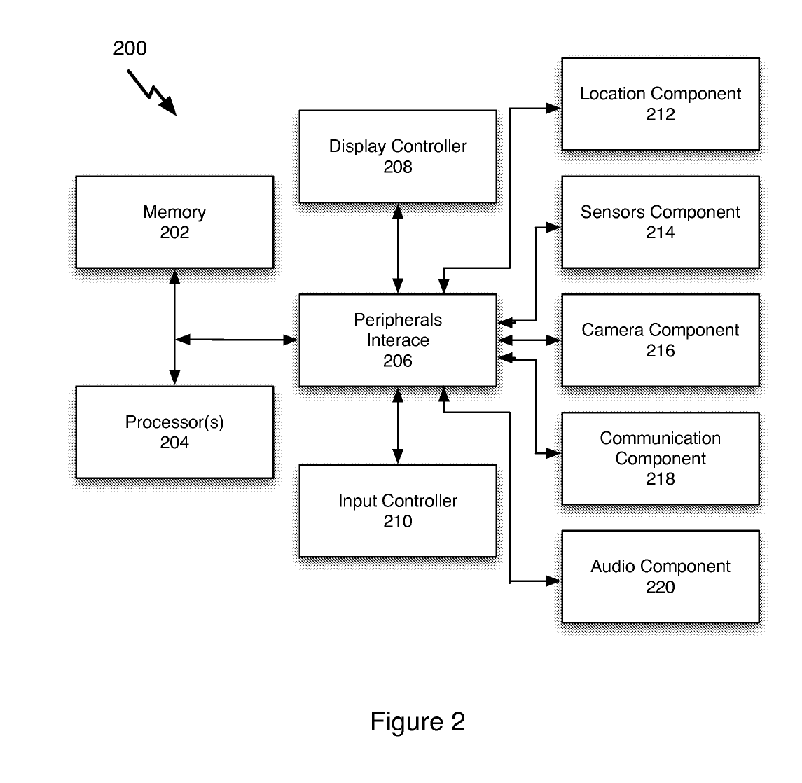

FIG. 2 is a block diagram of an exemplary mobile computing device.

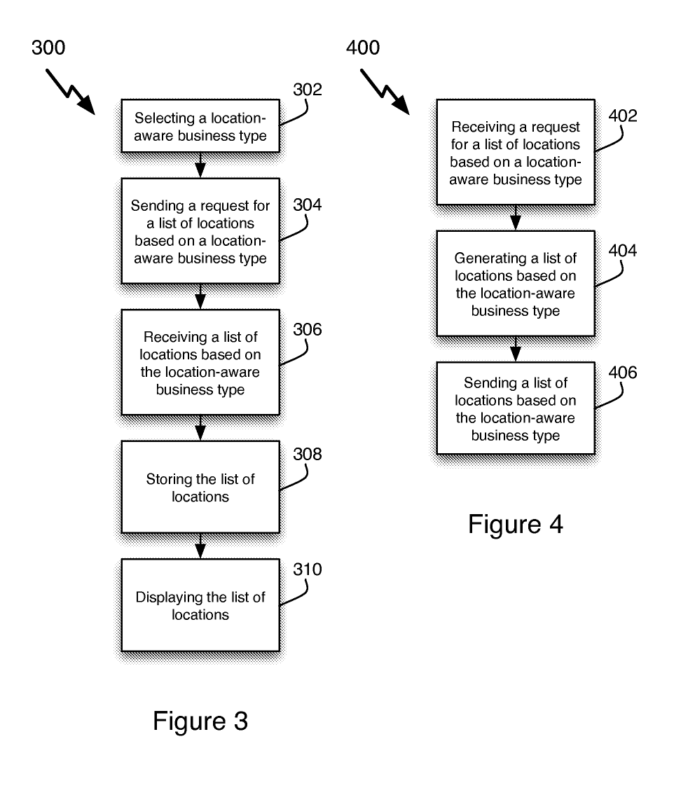

FIG. 3 illustrates an embodiment of a methodology operable by a mobile computing device for selecting a location-aware business type and receiving a list of locations based on the location-aware business type.

FIG. 4 illustrates an embodiment of a methodology operable by a server for responding to a request for locations based on a location-aware business type.

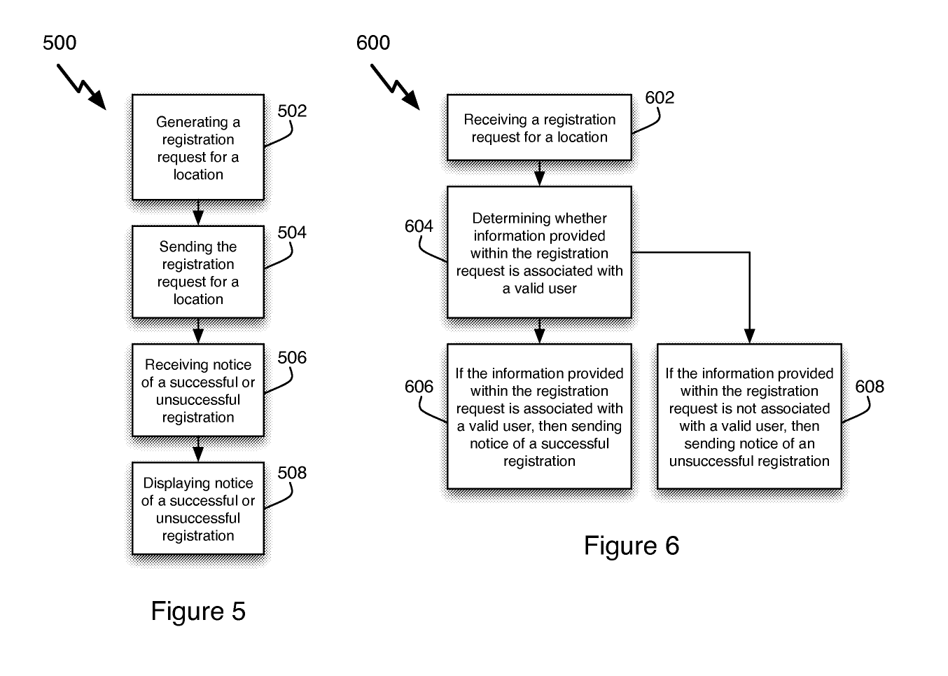

FIG. 5 illustrates another embodiment of a methodology operable by a mobile computing device for registering with a location-aware service.

FIG. 6 illustrates another embodiment of a methodology operable by a server for responding to registration requests.

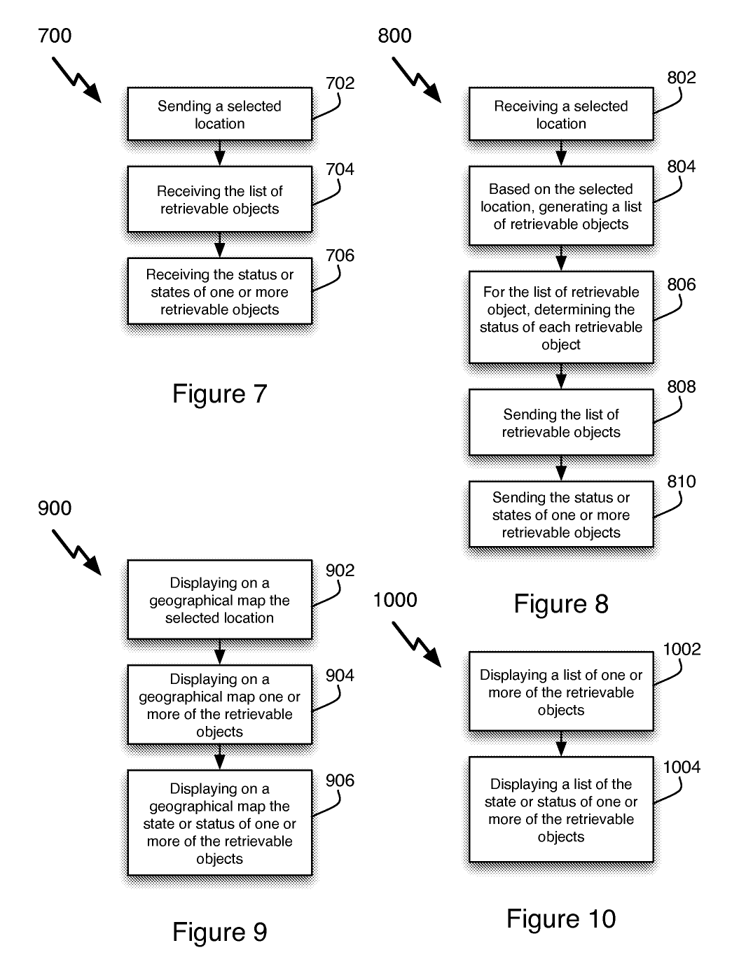

FIG. 7 illustrates another embodiment of a methodology operable by a mobile computing device for receiving objects available at a selected location and their associated status.

FIG. 8 illustrates another embodiment of a methodology operable by a server for responding to a request for objects available at a selected location and their associated status.

FIG. 9 illustrates another embodiment of a methodology operable by a mobile computing device for displaying a selected location on a geographical map and also displaying associated objects and their status.

FIG. 10 illustrates another embodiment of a methodology operable by a mobile computing device for displaying a list of objects associated with a selected location and the status or states of the object(s).

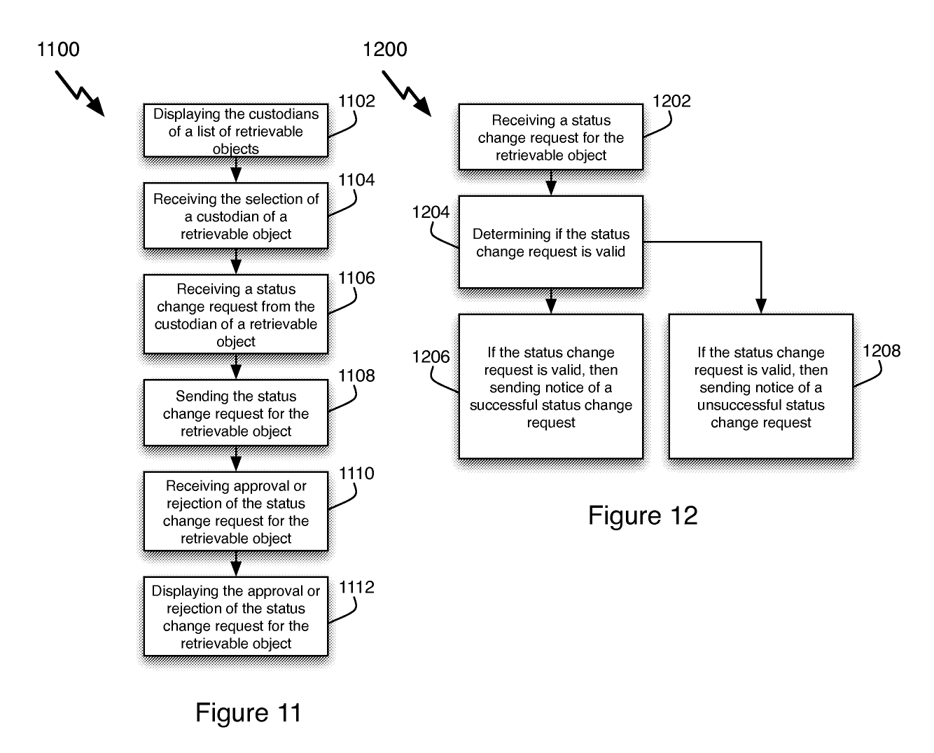

FIG. 11 illustrates another embodiment of a methodology operable by a mobile computing device for making a status change request.

FIG. 12 illustrates another embodiment of a methodology operable by a server for responding to a status change request.

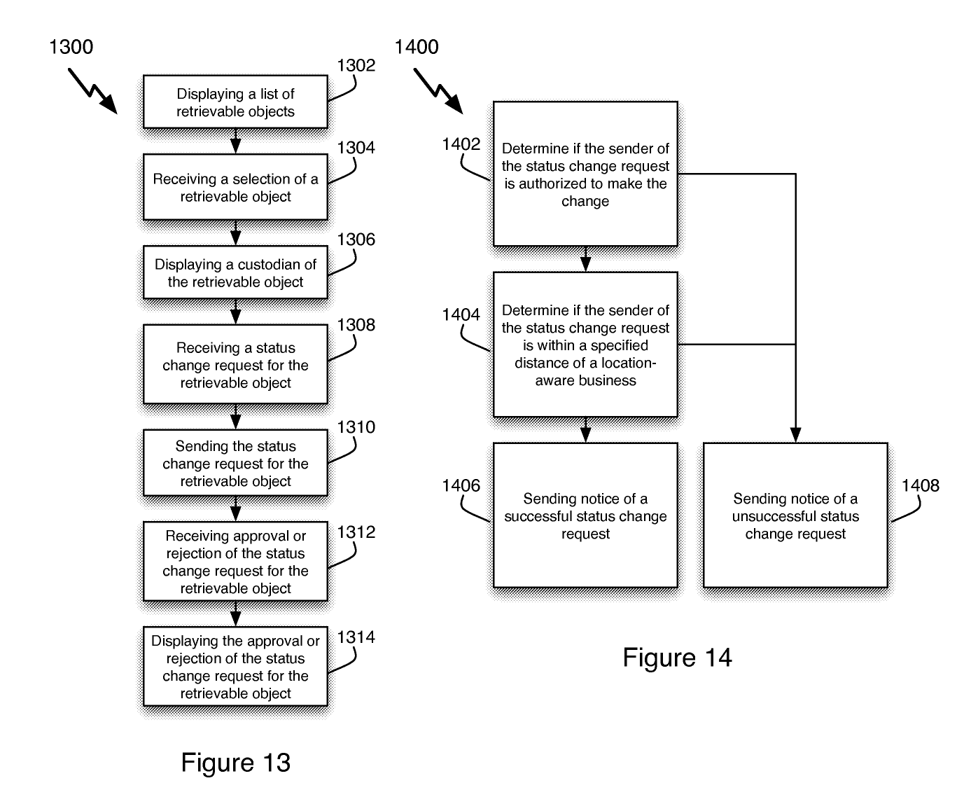

FIG. 13 illustrates another embodiment of a methodology operable by a mobile computing device for making a status change request.

FIG. 14 illustrates another embodiment of a methodology operable by a server for responding to a status change request.

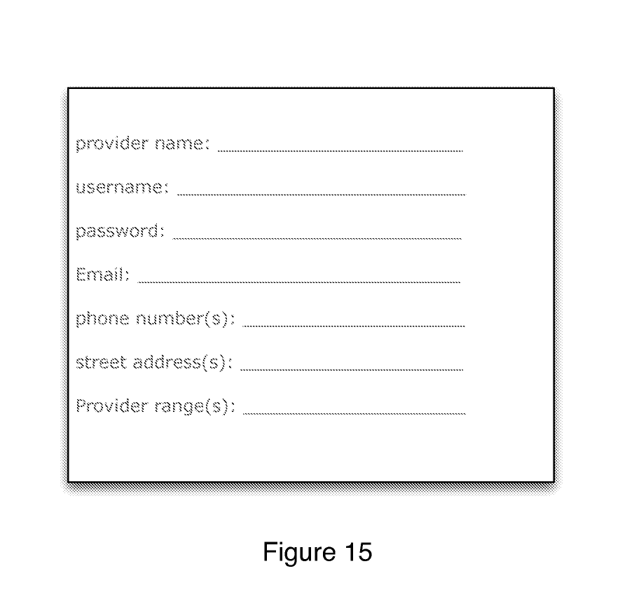

FIG. 15 illustrates an example of a record for storing information relating to a location-aware business.

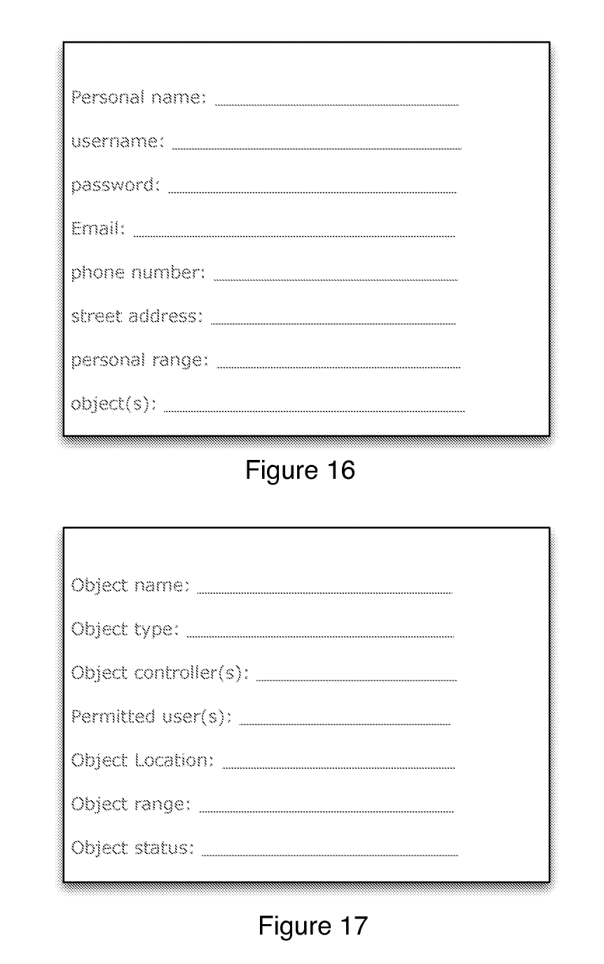

FIG. 16 illustrates an example of a record for storing information relating to a user of a location-aware service.

FIG. 17 illustrates an example of a record for storing information relating to an object associated with a location-aware service.

### DETAILED DESCRIPTION OF THE PREFERRED EMBODIMENTS

The present disclosure describes a method and system for providing location-aware services through the use of a location-aware application service provider. The method enables location-aware business service providers to obtain location-aware services for their users without having to develop and maintain computer software or server systems to provide the services.

A location-aware business service provider is an organization, business, or any other entity which utilizes one or more location-aware services for its users. A location-aware business service provider may or may not charge users for using location-aware services. In addition, the location-aware business service provider need not necessarily reside in the area where location-aware services are provided to its users.

A location-aware application service provider is an organization, business, or any other entity that provides a location-aware service to a location-aware business service provider and the location-aware business service provider's users. A location-aware application service provider may or may not charge location-aware business service providers or location-aware business service providers' users for using location-aware services. The location-aware application service provider may be generally responsible for developing and maintaining the computer software, server systems, computer networks, and other components that enable a location-aware service for one or more location-aware business service providers. As part of this provisioning of location-aware services, the location-aware application service provider may use different types of networks (e.g., Internet, mobile wireless, private intranets) or different types of server architectures (e.g., cloud).

A location-aware service is a service that provides information to a user of a location-aware business service provider. This information may include the location of a mobile computing device being used by the user. Based on the location of the mobile computing device, the location-aware service may be configured to provide information to the user. In addition, the location-aware service may also provide, as part of this information, selectable options that may be specified by a user via a mobile computing device. The location-aware service may be enabled by a number of different software or hardware components, such as a database component, a network interface component, an interface component, an authentication component, and others.

A computer or computing device is an electronic device structured to process and convey information. A computer or computing device includes a central processing unit (CPU), which is typically a programmable logic circuit, in electronic communication with memory, as well as associated devices such as keyboards and mice, displays, network cards (wired, wireless, or cellular), and/or other components for interacting with humans and computer networks.

A mobile computing device is any computing device that is generally not placed in a stationary or fixed location and is configured to be location-aware. The location-aware ability of the mobile computing device may be obtained through the use of a global positioning system (e.g., GPS, GLONASS, Compass, Galileo). In alternative embodiments, location-aware ability may be provided by a local positioning system, such as a mobile wireless network, radio triangulation, or a dead reckoning function that estimates current position based on a known prior position and other variables. In some embodiments, the mobile computing device may rely upon a network to provide it with location-aware ability, such as being informed of its relative location via its usage of a micro-cell or Wi-Fi hotspot. Moreover, in some embodiments, the mobile computing device need not receive the location-aware information, but rather that information is provided to the location-aware service by an underlying network function.

The disclosed method and system enables a location-aware business service provider to obtain location-aware services for its users via a location-aware application service provider. In one embodiment, the location-aware application service provider maintains a server system, such as a server system comprising a computer processor, computer readable storage media coupled to the processor, a network interface coupled to the processor, and software stored in the computer readable storage media and executable by the processor. The location-aware application service provider uses this server system (or more than one server system) to provide location-aware services. A location-aware business service provider may obtain location-aware services from the location-aware application service provider.

Using information provided by the location-aware business service provider, the location-aware application service provider may configure one or more location-aware services. In an alternative embodiment, the location-aware application service provider may provide an interface, such as a webpage or application interface, that allows a location-aware business service provider to configure the location-aware service. In a preferred embodiment, the location-aware business service provider may enter data into the location-aware service through the use of designated areas on the webpage. The webpage may require the location-aware business service provider to create an account by providing basic identifying information before entering data. The location-aware business service provider may create a username and password to enable future access to the account.

The configuration of the location-aware service may contain default information and options to be provided to users of the location-aware business service provider. The default information and options may be enabled or disabled by the location-aware business service provider. In some embodiments, the location-aware business service provider may provide information to configure the location-aware service, such as information that may only be presented to a user if the user meets specified criteria based on location, date, time, weather, merchandise availability, delivery availability, or other variables that may be supplied to or determined by the location-aware service, either by itself or pursuant to further instructions from the location-aware business service provider or the location-aware application service provider. Moreover, in some embodiments, the location-aware business service provider may provide information to configure the location-aware service, such as selectable options that may only be presented to a user if the user meets specified criteria based on location, date, time, weather, merchandise availability, delivery availability, or other variables that may be supplied to or determined by the location-aware service, either by itself or pursuant to further instructions from the location-aware business service provider or the location-aware application service provider. In some embodiments, these variables may depend on the location of the user. In other embodiments, these variables may also depend on the location of the location-aware business service provider or where a physical or virtual service or product is to be provided to a user. The selectable options may be configured in some embodiments to rely on only the location of a user or may be configured in some embodiments to rely on a combination of variables.

As an example, the location-aware service may be configured with data comprising the name of the location-aware business service provider, one or more business location addresses, a maximum distance from a given business location address where a user can access information via a location-aware service or selectable options relating to that business location address, a list of authorized users, and other information relevant to use of the location-aware service. This information may then be stored by the location-aware service in the computer readable storage media of a server system or in other computer readable storage media that may transmit the data to the location-aware service via a network when the data is required by the location-aware service.

The location-aware service may be enabled to provide a client application to the user via an Internet-based application download service such as an application store, wherein the application store may be specific to a particular mobile operating system, such as Android, Apple, Windows Mobile, or BlackBerry. In other embodiments, such functionality may also be provided by other types of networks or forms of communication, such as mobile wireless data systems or private networks. In some embodiments, it is also not necessary for an application to be downloaded to the mobile computing device, such as where the mobile computing device interacts with a webpage.

In some embodiments, the user may use the client application or other interface to identify the location-aware business service provider, such as choosing a location-aware business service provider from a list of location-aware business service providers. In some embodiments, the user may select a location-aware business service provider by choosing a specific application to download from an application store or by specifying information to a browser that resolves to a specific interface. In some embodiments, the location-aware business service provider may specify to the location-aware service that it cannot be selected by a user unless that user resides within a certain location or has authorization to use the location-aware service obtained from the location-aware business service provider.

In some embodiments, the location-aware service will regularly receive updates regarding the identity and location of a user. In other embodiments, the location-aware service may receive information regarding the user's identity and location when the user submits a service request to the location-aware service, such as through a client application. The location-aware service may also use a unique serial number of the user's mobile computing device or other identifying information unique to the user's mobile computing device to identify the user within the location-aware service. In other embodiments, the user may provide uniquely identifying information via the client application or another user interface to the location-aware service.

In some embodiments the user may receive information or selectable options from the location-aware service on the behalf of a location-aware business service provider. The user may then review the information or select an option. If an option is selected, the client application will transmit that selected option to the location-aware service. In response to the selected option, in some embodiments the location-aware service may provide additional information or selectable options to the user via the client application or other interface. In other embodiments, the location-aware service may also respond to the option selected by providing information or inquiries to the location-aware business service provider. It is also to be understood that in some embodiments, the information and selectable options will reside in the client application, which may be updated with new information and selectable options from time to time by the location-aware service. In such embodiments, the client application rather than the location-aware service may determine which information and selectable options should be presented to a user of the location-aware business service provider. In addition, in some of those embodiments, the client application may also directly communicate information or inquiries to the location-aware business service provider. For example, the location-aware application service provider may supply the location-aware business service provider with a second client application to handle the information and inquiries sent from client applications being used to serve users of the location-aware business service provider. In some embodiments, such communication may occur directly between the client applications of the location-aware business service provider and its users, while in other embodiments the communication may occur indirectly though the location-aware service.

It is not necessary for the location-aware business service provider to develop specialized computer software to implement the method, nor is it necessary for the location-aware business service provider to interact with the user in person.

In some embodiments, if user information transmitted to the location-aware service is valid within the parameters defined by the location-aware business service provider, the location-aware service may provide a first set of information or selectable options to such a user and if it is not valid it may provide a second set of information or selectable options to such a user.

In a preferred embodiment, the location-aware business service provider may enter the data using a computer comprising a computer processor, computer readable storage media coupled to the processor, a network interface coupled to the processor, and software stored in the computer readable storage media and executable by the processor, wherein the computer is accessible to the location-aware business service provider. The data entered by the location-aware business service provider may be stored in the computer readable storage media of the computer accessible to the location-aware business service provider. The computer accessible to the location-aware business service provider may transmit the data to the server system of the location-aware service via a network.

In one embodiment, the business location address and/or the user's location address may be translated into its latitude and longitude coordinates. In one embodiment, the location-aware business service provider may add additional authorized users to the list of authorized users by accessing the location-aware business service provider's pre-existing account on the location-aware service.

In one embodiment, the list of location-aware business service providers may be sorted by distance from the user's current location.

In one embodiment, the user's mobile computing device and the location-aware business service provider's computer are both client systems in relation to the location-aware application service provider's server system. The server system is used to provide the location-aware service. The user's client system acts as a proxy and sends its identification and location information and the service request to the server system. The server system relays this information to the location-aware business service provider's client system if the user's client system is within the required distance established by the location-aware business service provider and if the user is an authorized user, if applicable. This creates a communication channel over the Internet between the user's client system and the location-aware business service provider's client system. The location-aware business service provider can use this communication channel to serve its user's needs. In some embodiments, the location-aware business service provider may know all its active users' locations via this system, and may also manage users as they enter its service queue.

In another embodiment, the user may be prompted by the location-aware service, such as through the client application, to enter a password or security code to select a location-aware business service provider from the list of location-aware business service providers. Once the user is authenticated via the server system, a secure communication channel is created between the user's client system and the server system.

In one embodiment, after a user is validated by the server system, the user is prompted to select a service from a list of services offered by the location-aware business service provider. In another embodiment, a user is notified of location-aware business service provider offerings via e-mail and marketing.

In one embodiment, a location-aware business service provider can revoke user authorization at any time. In another embodiment, a user can cancel his or her membership using the application.

In a preferred embodiment, a location-aware business service provider may use the disclosed method and system for queue management.

In some embodiments, further visual recognition of users may be required. Such visual recognition may entail use of the client application.

In some embodiments, a location-aware business service provider may provide confirmation of having provided a service or product to a user.

With reference to FIG. 1, there is shown one embodiment of an exemplary location-aware system 100 that may comprise a plurality of system entities, such as, for example, a Server 102, a Network 104, a Tablet 106, a Smartphone 108, and a Personal Computer 110. Server 102 is capable of operatively communication via Network 104 with Tablet 106, Smartphone 108, or Personal Computer 110. In addition, Tablet 106, Smartphone 108, or Personal Computer 110 may capable of operatively communicating with each other via Network 104. Network 104 may consist of a variety of different network technologies, which for example may be the Internet, a private network, a Virtual Private Network, a Wi-Fi network, a cellular data network, an interconnection of network services, or any other system which communicates using packetized communication. In various embodiments, Server 102 may consist of a combination of software or hardware components, such as a database component, a network interface component, an interface component, an authentication component, and others, to perform any server functionality described herein. In related aspects, one or more of the system entities may be comprised of distributed components, such as cloud computing, to provide the functionality of one or more of the system entities. In further related aspects, one or more of the system entities may perform the function of another system entity, such as Tablet 106, Smartphone 108, or Personal Computer 110 performing steps described for Server 102 or vice versa.

With reference to FIG. 2, there is shown one embodiment of an exemplary mobile computing device 200, which may perform the functions of Tablet 106, Smartphone 108, or Personal Computer 110. Within this embodiment, Peripheral Interface 206 operatively communicates with Memory 202, Processor(s) 204, Display Controller 208, Input Controller 210, Location Component 212, Sensors Component 214, Camera Component, 216, Communication Component 218, and Audio Component 220. Peripheral Interface 206 may act to exchange communications between any component or other element that it is operatively in communication with. Processor 204 and Memory 202 may also be able to operatively communication with each other without exchanging communication with Peripheral Interface 206.

Memory 202 may provide storage of information for use with the mobile computing device, such as operating software and applications. Processor(s) 204 carries out instructions according to information stored in memory 202 or within the processor. Display Controller 208 may handle displaying information on an electronic display according to instructions sent from Processor(s) 204. Input Controller 210 may handle receiving inputs from a control device, such as a keyboard, switches, buttons, a touch-screen, or a fingerprint recorder and using such inputs to provide information to Processor(s) 204. Location Component 212 may handle determining the location of the mobile computing device, such as by receiving information from a global positioning system (e.g., GPS, GLONASS, Compass, Galileo), a local positioning system, such as a mobile wireless network, radio triangulation, or a dead reckoning function that estimates current position based on a known prior position and other variables, or from information provided by a communication network. Location Component 212 may provide the location of the mobile computing device upon request from Processor(s) 204 or may provide such information on a regular interval or continuous basis.

Sensors Component 214 may handle receiving information from sensors within the mobile computing device that detect movement, temperature, or other aspects of the physical state of the mobile computing device and forwarding such information to Processor(s) 204. Camera Component 216 may handle camera(s) contained within the mobile computing device based on instructions from Processor(s) 204 or send data recorded from such camera(s) to Processor(s) 204. Communication Component 218 may handle communications between the computing device and other networks, such as cellular networks, Wi-Fi networks, Bluetooth networks, ZigBee networks, near-field communication networks, etc. Audio Component 220 may handle recording or playing of audio using speakers, microphones, or audio interfaces contained in the mobile computing device.

The description of mobile computing device 200 is merely exemplary of a device that may interact with the location-aware system 100. A wide variety of products, such as iPhones, Blackberries, Android-based phones and tablets, iPads, that are mobile computing devices with a location component or equivalent functionality that allows such devices to be used with the location-aware system 100. In addition, Personal Computer 110 may be implemented with a wide variety of additional products, such as Mac and Windows based computers.

With reference to FIG. 3, there is shown an embodiment of a methodology 300 operable by a mobile computing device for selecting a location-aware business type and receiving a list of locations based on the location-aware business type. At 302, a mobile computing device may select a location-aware business type. The location-aware service may offer a wide variety of location-aware business types, such as schools, parking facilities, restaurants, secured multi-tenant locations, or any other place of business that requires location-aware services. At 304, a mobile computing device may send a request for a list of locations based on a location-aware business type, such as to a server. In some embodiments, the sending of the request may further include providing the location of a mobile computing device. In further embodiments, the sending of the request may further include providing parameters that the list of locations should satisfy, such as whether a location has parking or is open. At 306, a mobile computing device may receive, such as from a server, a list of locations based on the location-aware business type as well as any other information that was sent along with the request. At 308, a mobile computing device may store the list of locations for processing or future retrieval. At 310, a mobile computing device may display the list of locations.

With reference to FIG. 4, there is shown an embodiment of a methodology 400 operable by a server for responding to a request for locations based on a location-aware business type. At 402, a server may receive a request, such as from a mobile computing device, for a list of locations based on a location-aware business type. In some embodiments, the receiving of the request may further include receiving the location of a mobile computing device. In further embodiments, the receiving of the request may further include receiving parameters that the list of locations should satisfy, such as whether a location has parking or is open. At 404, a server may generate a list of locations based on the location-aware business type. In some embodiments, a server may use the location of the mobile computing device in determining which locations should be part of the list. In further embodiments, a server may also use parameters that the list of locations should satisfy in determining which locations should be included in the list. In alternative embodiments, a server may utilize lists previously generated and stored on the server to form such lists. At step 406, a server may send the list of locations based on the location-aware business type, such as to a mobile computing device.

With reference to FIG. 5, there is shown another embodiment of a methodology 500 operable by a mobile computing device for registering with a location-aware service. At 502, a mobile computing device may generate a registration request for a location, such as a school or a parking facility. In some embodiments, this step may further include requiring that the user enter a username and password into a mobile computing device for use with the registration request. In other embodiments, this step may further include requiring the user to enter a unique key or pin number for use with the registration request. In yet other embodiments, this step may further include requiring the user to scan his or her fingerprint with a mobile computing device for use with the registration request. At 504, a mobile computing device may send the registration request for a location, such as to a server. At 506, a mobile computing device may receive notice of a successful or unsuccessful registration. In some embodiments, the notice may also include information regarding why a registration was unsuccessful. At 508, a mobile computing device may display a notice of a successful or unsuccessful registration. In some embodiments, a mobile computing device may also display information regarding why a registration was unsuccessful.

With reference to FIG. 6, there is shown another embodiment of a methodology 600 operable by a server for responding to registration requests. At 602, a server may receive a registration request for a location. In some embodiments, this step may further include receiving a username and password as part of the registration request. In other embodiments, this step may further include receiving a unique key or pin number as part of the registration request. In yet other embodiments, this step may further include receiving confirmation from a mobile computing device that a user had a valid fingerprint scan as part of the registration request. At 604, a server may determine whether the information provided with the registration request is associated with a valid user of the location-aware service. In some embodiments, a server may also determine whether the information provided with the registration request allows a valid user of the location-aware service to access services associated with a specific location or retrievable object. At 606, a server may send a notice of a successful registration, such as to a mobile computing device, if the information provided with the registration request is associated with a valid user of the location-aware service. In some embodiments, a server may send such a notice only if the information provided with the registration request allows a valid user of the location-aware service to access services associated with a specific location or retrievable object. At 608, a server may send a notice of an unsuccessful registration, such as to a mobile computing device, if the information provided with the registration request is not associated with a valid user of the location-aware service or does not meet other required conditions. In some embodiments, a server may include with a notice of an unsuccessful registration the reason that registration was denied.

With reference to FIG. 7, there is shown another embodiment of a methodology 700 operable by a mobile computing device for receiving objects available at a selected location and their associated status. At 702, a mobile computing device may send a selected location, such as a school or a parking facility. At 704, a mobile computing device may receive a list of retrievable objects available at such a location. At 706, a mobile computing device may also receive the status or states of one or more of the retrievable objects at such a location. In some embodiments, the list of retrievable objects may include for each object all or a portion of the information described herein with respect to the object record of FIG. 17.

With reference to FIG. 8, there is shown another embodiment of a methodology 800 operable by a server for responding to a request for objects available at a selected location and their associated status. At 802, a server may receive a selected location, such as a school or a parking facility. At 804, a server may generate a list of retrievable objects based on a selected location. In some embodiments, the server may use the location of the mobile computing device in determining which retrievable objects should be part of the list. In further embodiments, a server may also use parameters that the list of locations should satisfy, such as constraints present in records associated with the retrievable object as shown in FIGS. 15-17, in determining which retrievable objects should be included in the list. In alternative embodiments, a server may utilize lists previously generated and stored on the server to form such lists. At 806, a server may determine the status of each retrievable object, such as by using information described herein with respect to the object record shown in FIG. 17, or by checking a different set of records. At 808, a server may send a list of retrievable objects available at such a location. At 810, a server may also send the status or states of one or more of the retrievable objects as such a location. In some embodiments, the list of retrievable objects may include for each object all or a portion of the information shown in the object record of FIG. 17.

With reference to FIG. 9, there is shown another embodiment of a methodology 900 operable by a mobile computing device for displaying a selected location on a geographical map and also displaying associated objects and their status. At 902, a mobile computing device may display on a geographical map a selected location. At 904, a mobile computing device may display on a geographical map one or more of retrievable objects available at a location. At 906, a mobile computing device may display on a geographical map the state or status of one or more of the retrievable objects at the location. In some embodiments, the indication of status of a retrievable object may be provided in the form of text. In further embodiments, the indication of the status of a retrievable object may be provided in the form of a graphical indicator, such as a checkmark.

With reference to FIG. 10, there is shown another embodiment of a methodology 1000 operable by a mobile computing device for displaying a list of objects associated with a selected location and the status or states of the object(s). At 1002, a mobile computing device may display a list of one or more of retrievable objects available at a location. At 1004, a mobile computing device may display a list of the state or status of one or more of the retrievable objects at the location. In some embodiments, the indication of status of a retrievable object may be provided in the form of text. In further embodiments, the indication of the status of a retrievable object may be provided in the form of a graphical indicator, such as a checkmark.

With reference to FIG. 11, there is shown another embodiment of a methodology 1100 operable by a mobile computing device for making a status change request. At 1102, a mobile computing device may display the custodian(s) associated with a list of a retrievable object. In some embodiments, each object may have one or more custodians. In further embodiments, the custodian(s) of each object may be identified by the “object(s)” field in the user record shown in FIG. 16. In further embodiments, the custodian(s) of each object may also be identified by the “object controller(s)” field or “permitted user(s)” field in the object record shown in FIG. 17. At 1104, a mobile computing device may receive the selection of a custodian associated with a retrievable object. At 1106, a mobile computing device may receive a status change request for a custodian associated with a retrievable object. In some embodiments, only a custodian(s) associated with a retrievable object may be permitted to enter a status change request in a mobile computing device for the retrievable object associated with the custodian. At 1108, a mobile computing device may send a status change request for a retrievable object. In some embodiments, such a status change request may further include information regarding the identity of a user of the mobile computing device and the mobile computing device's location. At 1110, a mobile computing device may receive notice of the approval or rejection of the status change request sent in 1108. In some embodiments, the notice of rejection may further include information regarding why the status change request was rejected. At 1112, a mobile computing device may display the notice of approval or rejection of the status change request received in 1110.

With reference to FIG. 12, there is shown another embodiment of a methodology 1200 operable by a server for responding to a status change request. At 1202, a server may receive a status change request, such as from a mobile computing device. At 1204, a server may determine if a status change request is valid. At 1206, if the status change request is valid, a server may send notice of a successful change request. At 1208, if the status change request is valid, a server may send notice of an unsuccessful change request. In some embodiments, the notice of rejection may further include information regarding why the status change request was rejected.

With reference to FIG. 13, there is shown another embodiment of a methodology 1300 operable by a mobile computing device for making a status change request. At 1302, a mobile computing device may display a list of retrievable objects. In some embodiments, the list of retrievable objects may be constrained by use of the mobile computing device's location. At 1304, a mobile computing device may receive a selection of a retrievable object. At 1306, a mobile computing device may display one or more custodian(s) associated with a retrievable object. At 1308, a mobile computing device may receive a status change request for the selected retrievable object. At 1310, a mobile computing device may send a status change request for the selected retrievable object. At 1312, a mobile computing device may receive notice of the approval or rejection of the status change request sent in 1310. In some embodiments, the notice of rejection may further include information regarding why the status change request was rejected. At 1314, a mobile computing device may display the notice of approval or rejection of the status change request received in 1312.

At 1106, a mobile computing device may receive a status change request for a custodian associated with a retrievable object. In some embodiments, only a custodian(s) associated with a retrievable object may be permitted to enter a status change request in a mobile computing device for the retrievable object associated with the custodian. At 1108, a mobile computing device may send a status change request for a retrievable object. In some embodiments, such a status change request may further include information regarding the identity of a user of the mobile computing device and the mobile computing device's location. At 1110, a mobile computing device may receive notice of the approval or rejection of the status change request sent in 1108. In some embodiments, the notice of rejection may further include information regarding why the status change request was rejected. At 1112, a mobile computing device may display the notice of approval or rejection of the status change request received in 1110.

With reference to FIG. 14, there is shown another embodiment of a methodology 1400 operable by a server for responding to a status change request. At 1402, a server may determine if a user is authorized to make a status change request. At 1404, a server may determine if a status change request is within a specified distance of a location-aware business. In some embodiments, the specified distance selected may be determined by using one or more ranges provided in location records, user records, or object records. At 1406, a server may send notice of a successful status change request if it has determined that the status change request is valid. At 1408, a server may send notice of an unsuccessful status change request if it has determined that the status change request is invalid. In some embodiments, a server may also include with notice of an unsuccessful status change request why the status change request was invalid.

With reference to FIG. 15, there is shown an example of a location record 1500 for storing information relating to a location-aware business. Each location-aware business serviced by a location-aware-service may be associated with an entry in the form of location record 1500. Location record 1500 may provide a field for storing a provider name associated with a location-aware business. Location record 1500 may provide fields for storing a username and password associated with a location-aware business. Location record 1500 may provide fields for one or more email address, phone numbers, and street addresses associated with a location-aware business. Location record 1500 may also provide fields identifying retrievable objects available at each street address associated with a location-aware business. Location record 1500 may also provide fields identifying ranges for each street address associated with a location-aware business. In determining whether a status change request is valid, a server may use such ranges in location record 1500 to determine if the user sending the status change request is within such a range of a street address associated with a location-aware business. If the user is not within such a range of a street address associated with a location-aware business, the server may reject the status change request.

With reference to FIG. 16, there is shown an example of a user record 1600 for storing information relating to a user of a location-aware service. Each user serviced by a location-aware-service may be associated with an entry in the form of user record 1600. User record 1600 may provide a field for storing a provider name associated with a user. User record 1600 may provide fields for storing a username and password associated with a user. User record 1600 may provide fields for an email address, a phone number, and a street addresses associated with a user. User record 1600 may also provide fields for storing one or more locations of a mobile computing device or mobile computing devices associated with a user. User record 1600 may also provide fields identifying retrievable objects controlled by or accessible to a user. User record 1600 may also provide fields identifying a personal range for each user. In determining whether a status change request is valid, a server may use such a personal range in User record 1600 to determine if the user sending the status change request is within such a personal range of a retrievable object's location. If the user is not within such a range of a retrievable object's location, the server may reject the status change request. In some embodiments, one or more personal ranges may be stored in user record 1600 wherein each personal range is associated with a particular location-aware business or retrievable object. Such an approach may be advantageous where a particular user has acted in an undesirable manner and the user's ability to make status change requests should be constrained to a narrower range to ensure good behavior.

With reference to FIG. 17, there is shown an example of an object record 1700 for storing information relating to an object (e.g., a retrievable object) associated with a location-aware service. Object record 1600 may provide a field for storing one or more names associated with an object. Object record 1600 may provide a field for storing one or more types associated with an object. For example, an object may have a type such as student, vehicle, parking spot, or food order. In some embodiments, an object may have a type describing a non-physical entity, such as services provided by a location-aware business (e.g., personal escort, appointment with a trainer). Object record 1600 may provide a field for storing users who are object controllers of an object. A location-aware service may use information regarding object controllers to determine which users may make changes to any information stored in a field of Object record 1600. Object record 1600 may provide a field for storing users who are permitted users of an object. In determining whether a status change request is valid, a server may use such permitted users in Object record 1600 to determine if the user sending the status change request is permitted to make a status change request. If the user is not a permitted user of the object, the server may reject any status change request by such a user in association with that object. Object record 1600 may provide a field for storing the location of the object, such as a street address of a location-aware business or user or a location of a mobile computing device. In some embodiments, the location of the object may be the objects actual location. In further embodiments, the location of the object may be object's last known location, its expected location, the street address of the last user who made a valid status change request for the object, or the street address of an object controller associated with the object.

Object record 1600 may provide a field for storing a range associated with the object. In determining whether a status change request is valid, a server may use such a range in object record 1600 to determine if a user sending a status change request for the object is within such a range of an object's location. If a user is not within such a range of an object's location, the server may reject the status change request. Object record 1600 may provide a field for storing status information regarding an object. Examples of status information may be whether an object is checked in or out of a location, whether an object is available to perform certain functions, or when an object will be available for a status change request. In determining whether a status change request is valid, a server may use such status information in object record 1600 to determine if a status change request can occur. If the status information associated with a status change request conflicts with the requested status change, the server may reject the status change request. For example, if the status of an object is that it has been “checked out”, than a status change request to check out that object may be rejected.

In some embodiments, the status information associated with one or more objects may be used by a server or mobile computing device to generate reports. For example, the status of information for objects with the object student type may be used to generate reports describing whether an object was at a specific location on a regular basis or during certain time periods, whether an object was subject to a particular type of status change request on a regular basis or during certain time periods, whether status change requests in general for an object were conducted within a certain time frame, or what objects were at a location or associated with a location-aware business or user on a regular basis or during certain time periods. In such embodiments, the status information may include all necessary information to generate such reports. For example, the status information may contain a log of some or all status change requests, time stamps for each status change request, or the users associated with each status change request. In further embodiments, the status information may also include similar information for status change requests that were invalidated and may also include information describing the reason why any status change request was rejected.

### Application of Method to School Drop-Off and Pick-Up

In one embodiment, the disclosed method is used to manage a system for dropping-off and picking up children by authorized adults from a school to increase safety and dismissal efficiency. Any school may sign up to use the method and provide its details using a webpage provided by the location-aware service, without requiring any software development by the school. A school may also provide a list of authorized adults with permission to pick up a given student.

In one embodiment, an authorized adult may download a client application from an application store for mobile computing devices using an Android, Apple, Windows Mobile, or BlackBerry operating system. The authorized adult may then use the client application on his or her mobile computing device to send identification information to the server system used by the location-aware service. Once authorized, the authorized adult can claim his or her child or children at the school upon entering the zone defined by the maximum distance set by the school. For example, the client application or location-aware service may be configured to send a message, such as an e-mail or a notification to a webpage, that is monitored by school personnel. When a school official sees the message, he or she may instruct the child or children that they may leave to meet the authorized adult or may assign school personnel to bring the child or children to the authorized adult's vehicle.

An additional module may allow the authorized adult to sign for the child or children he or she is authorized to pick up using his or her mobile computing device. The signature may be stored with a timestamp in the computer readable storage media of the server system used by the location-aware service. The server system used by the location-aware service may then transmit the location of and signature for the authorized adult as a message, such as an e-mail or notification to a webpage, that is monitored by school personnel. When a school official sees the message, he or she may instruct the child or children that they may leave to meet the authorized adult or may assign school personnel to bring the child or children out to the authorized adult's vehicle. For example, a client application may be configured to send the identity, location, and a service request from the user of a mobile computing device to a computing device used by the school. This transmission may occur directly between the devices, such as through an IP message (e.g., UDP) or indirectly via the location-aware service. This information when received by the computing device used by the school is seen by a school official. The computing device used by the school may be a mobile computing device such as an iPad or Android tablet. The location-aware service may provide a different client application for use by the school for handling the information sent to or from the location-aware service to the computing device used by the school (the location-aware business service provider in this case). The location-aware service may also use a webpage as an interface to the computing device used by the school. When the school official receives the information on this computing device, he or she may instruct the child or children that they may leave to meet the authorized adult or may assign school personnel to bring the child or children to the authorized adult's vehicle.

In this embodiment, further visual recognition of the authorized adult by representatives of the school may be required. Alternatively, visual recognition of the authorized adult may be sent via the client application by using a camera on the mobile computing device and then having the resulting image sent to the school via the location-aware service.

In addition, the server system used by the location-aware service may also transmit the location and authentication information uniquely identifying a mobile computing device running a client application to a computing device, such as an iPad or Android tablet, used by the school. The location-aware service may also use a webpage as an interface to the computing device used by the school. When the school official receives the information on the computing device used by the school, he or she may instruct the child or children that they may leave to meet the authorized adult or may assign school personnel to bring the child or children to the authorized adult's vehicle. The client application or webpage being observed by the school official may convey this information in the form of a checkmark that appears next to the name of the authorized adult confirming that they have signed up for pickup. He or she may then instruct the child or children that they may leave to meet the authorized adult or may assign school personnel to bring the child or children to the authorized adult's vehicle.

The method may also comprise additional steps that enable the school to transmit confirmation of pick-up to one or more parents or other authorized adults.

The advantages of this method include reduced wait time for parents or other authorized adults when picking up children from a school, reduced school staff time requirements to coordinate the process of picking up children, reduced need for parking in or around the school through increased efficiency, reduced equipment maintenance costs, reduced administrative work by school personnel, an effective method of maintaining records of signatures, and enhanced security through multiple checks. All these features are provided without any need for computer software development by the school.

### Application of Method to Vehicle Drop-Off and Pick-Up

In one embodiment, the disclosed method is used to manage a system for dropping-off and picking up vehicles by authorized drivers from a parking facility to increase safety and dismissal efficiency. Any parking facility may sign up to use the method and provide its details using a webpage provided by the location-aware service, without requiring any software development by the parking facility. A parking facility may also provide a list of authorized drivers with permission to pick up a given vehicle. A parking facility may consist of one or more structures, parking lots, or other locations suitable for storing vehicles.

In one embodiment, an authorized driver may download a client application from an application store for mobile computing devices using an Android, Apple, Windows Mobile, or BlackBerry operating system. The authorized driver may then use the client application on his or her mobile computing device to send identification information to the server system used by the location-aware service. Once authorized, the authorized driver can claim his or her vehicle(s) at the parking facility upon entering the zone defined by the maximum distance set by the parking facility. For example, the client application or location-aware service may be configured to send a message, such as an e-mail or a notification to a webpage, that is monitored by parking facility personnel. When a parking facility official sees the message, he or she may instruct that the vehicle may leave the parking facility or may assign parking facility personnel to bring the vehicle(s) to the authorized driver or a pre-determined drop-off/pick-up location.

An additional module may allow the authorized driver to sign for the vehicle(s) he or she is authorized to pick up using his or her mobile computing device. The signature may be stored with a timestamp in the computer readable storage media of the server system used by the location-aware service. The server system used by the location-aware service may then transmit the location of and signature for the authorized adult as a message, such as an e-mail or notification to a webpage, that is monitored by parking facility personnel. When a parking facility official sees the message, he or she may instruct that the vehicle may leave the parking facility or may assign parking facility personnel to bring the vehicle(s) to the authorized driver or a pre-determined drop-off/pick-up location. For example, a client application may be configured to send the identity, location, and a service request from the user of a mobile computing device to a computing device used by the parking facility. This transmission may occur directly between the devices, such as through an IP message (e.g., UDP) or indirectly via the location-aware service. This information when received by the computing device used by the parking facility is seen by a parking facility official. The computing device used by the parking facility may be a mobile computing device such as an iPad or Android tablet. The location-aware service may provide a different client application for use by the parking facility for handling the information sent to or from the location-aware service to the computing device used by the parking facility (the location-aware business service provider in this case). The location-aware service may also use a webpage as an interface to the computing device used by the parking facility. When the parking facility official receives the information on this computing device, he or she may instruct that the vehicle may leave the parking facility or may assign parking facility personnel to bring the vehicle(s) to the authorized driver or a pre-determined drop-off/pick-up location.

In this embodiment, further visual recognition of the authorized driver by representatives of the parking facility may be required. Alternatively, visual recognition of the authorized driver may be sent via the client application by using a camera on the mobile computing device and then having the resulting image sent to the parking facility via the location-aware service.

In addition, the server system used by the location-aware service may also transmit the location and authentication information uniquely identifying a mobile computing device running a client application to a computing device, such as an iPad or Android tablet, used by the parking facility. The location-aware service may also use a webpage as an interface to the computing device used by the parking facility. When the parking facility official receives the information on the computing device used by the parking facility, he or she may instruct that the vehicle may leave the parking facility or may assign parking facility personnel to bring the vehicle(s) to the authorized driver or a pre-determined drop-off/pick-up location. The client application or webpage being observed by the parking facility official may convey this information in the form of a checkmark that appears next to the name of the authorized driver confirming that they have signed up for pickup. He or she may then instruct that the vehicle may leave the parking facility or may assign parking facility personnel to bring the vehicle(s) to the authorized driver or a pre-determined drop-off/pick-up location.

The method may also comprise additional steps that enable the parking facility to transmit confirmation of pick-up to one or more drivers or other authorized adults.

The advantages of this method include reduced wait time for drivers or other authorized adults when picking up vehicles from a parking facility, reduced parking facility staff time requirements to coordinate the process of picking up vehicles, reduced need for waiting in or around the parking facility through increased efficiency, reduced equipment maintenance costs, reduced administrative work by parking facility personnel, an effective method of maintaining records of signatures, and enhanced security through multiple checks. All these features are provided without any need for computer software development by the parking facility.

### Application of Method to Restaurant Service

In one embodiment, the disclosed method is used to manage a system for receiving and fulfilling orders by a restaurant to increase efficiency and the time required to serve individual customers. Any restaurant may sign up to use the method and provide its details to the location-aware service using a webpage, without requiring any software development by the restaurant.

In one embodiment, a customer may download a client application from an application store for mobile computing devices using an Android, Apple, Windows Mobile, or BlackBerry operating system. The customer may then use the client application on his or her mobile computing device to send identification information to a server system used by the location-aware service. Once the customer's mobile computing device is recognized by the location-aware service, the customer can place his or her order. The restaurant may restrict placement of orders to a zone defined by the maximum distance set by the restaurant for placing orders. The server system used by the location-aware service may transmit the location of the customer to the restaurant as a message, such as an e-mail or other notification, so that the restaurant can prepare the customer's order in a timely manner and employees or other representatives of the restaurant may serve the customer by bringing his or her order out to his or her vehicle or ensuring the order is ready for the customer when he or she is expected to enter the restaurant but is not ready too early such that the customer's order becomes cold by the time it is picked up. The restaurant may also provide information regarding the availability of delivery personnel to the location-aware service, thereby allowing the restaurant to use the location-aware service to restrict coverage for food delivery orders or estimate the delivery time based on the availability of delivery personnel and the location of other pending delivery orders.

The advantages of this system include reduced wait time for customers, increased efficiency, increased customer satisfaction, and a method of verification by the restaurant to reduce the number of orders placed that are not ultimately picked up so as to reduce the monetary losses resulting from unclaimed orders. All these features are provided without any need for computer software development by the restaurant.

### Application of Method to Pre-Authorization by Fitness Center

In one embodiment, the disclosed method is used to manage a system for pre-authorizing users for entry into a fitness center. Any fitness center may sign up to use the method and provide its details using a webpage provided by the location-aware service, without requiring any software development by the fitness center. A fitness center may also provide a list of authorized users with permission to use the fitness center and provide photographic images identifying each authorized user.

In one embodiment, a user may download a client application from an application store for mobile computing devices using an Android, Apple, Windows Mobile, or BlackBerry operating system. The user may then use the client application on his or her mobile computing device to send identification information to a server system used by the location-aware service. The user may also use the client application on his or her mobile computing device to reserve the use of certain equipment for a period of time, an available spot in a class, or time with a personal trainer. Once the user's mobile computing device is recognized by the location-aware service, if the user is an authorized user his or her identity, image, and reservation information (if enabled) will be transmitted by the server system used by the location-aware service to a computer accessible to an employee or other representative of the fitness center, wherein the computer further comprises a monitor. The user's identity, image, and reservation information (if enabled) will appear on the monitor, enabling the fitness center employee or representative to identify the user as the user enters the fitness center and may further enable the fitness center employee or representative to approve or confirm reservations. Use of the method may be restricted to within a maximum distance set by the fitness center for pre-authorization.

The advantages of this system include increased efficiency and user satisfaction when checking into the fitness center. These features are provided without any need for computer software development by the fitness center.

### Application of Method to Pre-Authorization by a Tenant

In one embodiment, the disclosed method is used to manage a system for pre-authorizing users for entry into a secured multi-tenant location, such as a building or gated community where residences or businesses are not accessible to the public without authorization. Any secured multi-tenant location may sign up to use the method and provide its details using a webpage provided by the location-aware service, without requiring any software development by the secured multi-tenant location. A secured multi-tenant location may also provide a list of authorized users with permission to enter the secured multi-tenant location and provide photographic images identifying each authorized user.

In one embodiment, a user may download a client application from an application store for mobile computing devices using an Android, Apple, Windows Mobile, or BlackBerry operating system. The user may then use the client application on his or her mobile computing device to send identification information to a server system used by the location-aware service. The user may also use the client application on his or her mobile computing device to reserve the use of parking spaces for a period of time or to obtain entry to a tenant's or business's space, such as by a key, access card, or personal escort by secured multi-tenant location staff. Once the user's mobile computing device is recognized by the location-aware service, if the user is an authorized user his or her identity, image, and reservation information (if enabled) will be transmitted by the server system used by the location-aware service to a computer accessible to an employee or other representative of the secured multi-tenant location, wherein the computer further comprises a monitor. The user's identity, image, and reservation information (if enabled) will appear on the monitor, enabling the secured multi-tenant location employee or representative to identify the user as the user enters the secured multi-tenant location and may further enable the secured multi-tenant location employee or representative to approve, confirm, or fulfill reservations. Use of the method may be restricted to within a maximum distance set by the secured multi-tenant location for pre-authorization.

The advantages of this system include increased efficiency and user satisfaction when checking into the secured multi-tenant location. These features are provided without any need for computer software development by the secured multi-tenant location.

The specific order or hierarchy of steps of the processes disclosed herein are examples of exemplary approaches. Based upon design preferences, it is understood that the specific order or hierarchy of steps in the process may be rearranged while remaining within the scope of the present disclosure. The accompany method claims present elements of the various steps in a sample order, and are not meant to be limited to the specific order or hierarchy presented. Further, it is understood that additional steps may be performed with respect to the processes described herein, or that steps may be otherwise combined or omitted.

Those of skill in the art would appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes Compact Disc (CD), laser disc, optical disc, Digital Versatile Disc (DVD), floppy disk, and Blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein. All references cited herein are expressly incorporated by reference.

What is claimed is:

1. A non-transitory, computer-readable medium having computer-executable instructions for performing a method for providing location-aware services comprising, said method comprising:
receiving a first location associated with a mobile computing device;
receiving a status change request for an object;
retrieving a second location associated with the object;
retrieving one or more ranges;
determining if the first location and second location are within the one or more ranges; and
rejecting the status change request if the first location and second location are not within the one or more ranges.

2. A non-transitory, computer-readable medium having computer-executable instructions for performing a method as claimed in claim 1 wherein the method further comprises:
receiving a first user associated with the status change request;
retrieving a list of users associated with the object; and
rejecting the status change request if the first user is not within the list of users.

3. A non-transitory, computer-readable medium having computer-executable instructions for performing a method as claimed in claim 1 wherein the method further comprises:
retrieving status information associated with the object; and
rejecting the status change request if the status information conflicts with the status change request.

4. A non-transitory, computer-readable medium having computer-executable instructions for performing a method as claimed in claim 2 wherein the one or more ranges comprises:
a first range associated with a location.

5. A non-transitory, computer-readable medium having computer-executable instructions for performing a method as claimed in claim 4 wherein the one or more ranges further comprises:
a second range associated with the object.

6. A non-transitory, computer-readable medium having computer-executable instructions for performing a method as claimed in claim 5 wherein the one or more ranges further comprises:
a third range associated with the first user.

7. A system for providing location-aware services comprising:
a server capable of:
receiving a first location associated with a mobile computing device;
receiving a status change request for an object;
retrieving a second location associated with the object;
retrieving one or more ranges;
determining if the first location and second location are within the one or more ranges; and
rejecting the status change request if the first location and second location are not within the one or more ranges.

8. The system of claim 7 wherein the server is further capable of:
receiving a first user associated with the status change request;
retrieving a list of users associated with the object; and
rejecting the status change request if the first user is not within the list of users.

9. The system of claim 7 wherein the server is further capable of:
retrieving status information associated with the object; and
rejecting the status change request if the status information conflicts with the status change request.

10. The system of claim 8 wherein the one or more ranges comprises:
a first range associated with a location.

11. The system of claim 10 wherein the one or more ranges further comprises:
a second range associated with the object.

12. The system of claim 11 wherein the one or more ranges further comprises:
a third range associated with the first user.

13. A non-transitory, computer-readable medium having computer-executable instructions for performing a method for providing location-aware services comprising, said method comprising:
sending a first location associated with a mobile computing device;
sending a request for a list of locations based on a location type;
receiving the list of locations;
selecting a second location from the list of locations;
sending the selection of the second location;
receiving a list of objects associated with the second location;
receiving one or more ranges;
selecting an object;
receiving a status change request for the selected object;
determining if the first location and second location are within the one or more ranges; and
rejecting the status change request if the first location and second location are not within the one or more ranges.

14. A non-transitory, computer-readable medium having computer-executable instructions for performing a method as claimed in claim 13 wherein the method further comprises:
receiving a list of users associated with the selected object; and
rejecting the status change request if a user account associated with the mobile computing device is not within the list of users.

15. A non-transitory, computer-readable medium having computer-executable instructions for performing a method as claimed in claim 13 wherein the method further comprises:
receiving status information associated with the object; and
rejecting the status change request if the status information conflicts with the status change request.

16. A non-transitory, computer-readable medium having computer-executable instructions for performing a method as claimed in claim 14 wherein the one or more ranges comprises:
a first range associated with a location.

17. A non-transitory, computer-readable medium having computer-executable instructions for performing a method as claimed in claim 16 wherein the one or more ranges further comprises:
a second range associated with the object.

18. A non-transitory, computer-readable medium having computer-executable instructions for performing a method as claimed in claim 17 wherein the one or more ranges further comprises:
a third range associated with the user account.
